(19) United States
(12) Patent Application Publication
(10) Pub. No.: US 2025/0144731 A1
(43) Pub. Date: May 8, 2025

(54) WHEEL-GUIDED ATTACHMENT FOR A WELDING OR CUTTING TOOL

(71) Applicant: Jeremiah J. Grube, New Holstein, WI (US)

(72) Inventor: Jeremiah J. Grube, New Holstein, WI (US)

(21) Appl. No.: 18/504,465

(22) Filed: Nov. 8, 2023

(51) Int. Cl. B23K 7/10

(52) U.S. Cl. CPC B23K 7/10

(57) ABSTRACT

An assembly removably securable to a welding apparatus or a cutting apparatus is disclosed. The assembly includes a circular disc, a clamp removably securable to either apparatus, a cylindrical member secured to the clamp, and a shaft having opposite end portions. One of the end portions is rotatably mounted to an end portion of the cylindrical member. The other of the end portions has the circular disc rotatably mounted thereto.

The present subject matter is directed, in general, to a welding or cutting tool, and more particularly, to an assembly for attaching a wheeled guide to welding or cutting tools.

### BACKGROUND

Welding is a fabrication process to join metals or thermoplastics together by using high temperatures to melt abutting end portions, followed by cooling sufficiently to cause fusion of the abutting end portions. A filler material may be added to a joint to form a pool of molten material or weld pool that cools to form, based on the butt joint, a full-penetration joint or a fillet joint which is stronger than the base material. Many different energy sources can be used for welding, including a gas flame, an electric arc, a laser, an electron beam, friction, and ultrasound. Often in an industrial process, welding may be performed in many different environments including but not limited to open air, under water, and outer space.

Oxy-fuel welding (commonly called oxygen-acetylene welding, “oxy” welding, or gas welding) and oxy-fuel cutting are industrial processes that use fuel gases (or liquid fuels) and oxygen to weld or cut metals. In oxy-fuel welding, a welding torch is used to weld metals. Welding of metal results when two pieces of metal are heated to a temperature producing a shared pool of molten metal. The molten pool is often supplied with additional metal, called filler. Filler material selection depends on metal to be welded.

In oxy-fuel cutting, a torch heats metal to its autoignition temperature and a stream of oxygen is used to convert the metal to an oxide that flows as a mass of solid impurities floating on molten material. (See Oxy-Acetylene Handbook, Union Carbide Corp., 1975.)

Many welders and cutters are often confronted with tedious and perplexing tasks in cutting metal sheet or an equivalent workpiece in a satisfactorily straight line. His/her task is more difficult if the cut must be made around the circumference of a length of pipe. If cuts must be beveled so that two pieces of material can be properly joined by way of their abutting beveled edges, it is even more tedious and difficult to cope with such a task.

In view of risks associated with the present subject matter, it is desirable that an attachment for the neck of an acetylene torch head, a welding wand, and/or a plasma cutter be commercially available and be adapted and configured to serve as an effective deflector of sparks from an acetylene torch head, a welding wand, and/or a plasma cutter. As can be seen, there is also a need for a guide that enables the worker to maintain a cut line along a consistent distance from a part feature, such as an edge.

### SUMMARY

The present subject matter—which I call my NuClear Roller Guide product—is a disc-guided (or wheel-guided) assembly sized, adapted, and configured to be attached to a neck of an acetylene torch head, a welding wand, or a plasma cutter, to work as a guide between an operative tip (of the head, the wand, and the cutter) and the material being cut or welded. The present subject matter is also sized, adapted, and configured to serve as a safety deflector, for reducing injuries due to sparks hitting the face, body, or a gloved hand of a user, for reducing personal injury and need to replace user protective clothing.

The present subject matter is directed to an assembly removably securable to a welding or a cutting apparatus. The assembly includes a circular disc, a clamp removably secured to the apparatus, a cylindrical member secured to the clamp, and a shaft having opposite end portions, one of the end portions being rotatably mounted to an end portion of the cylindrical member, the other end portion having the disc rotatably mounted thereto.

### BRIEF DESCRIPTION OF THE DRAWING FIGURES

FIG. 1 is a side perspective view of a current embodiment of the present subject matter, as used in connection with an illustrative example of a prior art welding apparatus.

FIG. 2 presents a side elevational view of the current embodiment of the present subject matter, when used in connection with an example of a prior art cutting apparatus.

FIG. 3 is a side view depicting rotational components of the present subject matter.

FIG. 4 is an exploded side elevational view of a variety of components associated with the illustrated embodiment of the assembly mechanism of the present subject matter.

Throughout the drawing figures and detailed description (below), similar reference numerals shall be used to refer to features of the present subject matter which are similar.

### DETAILED DESCRIPTION

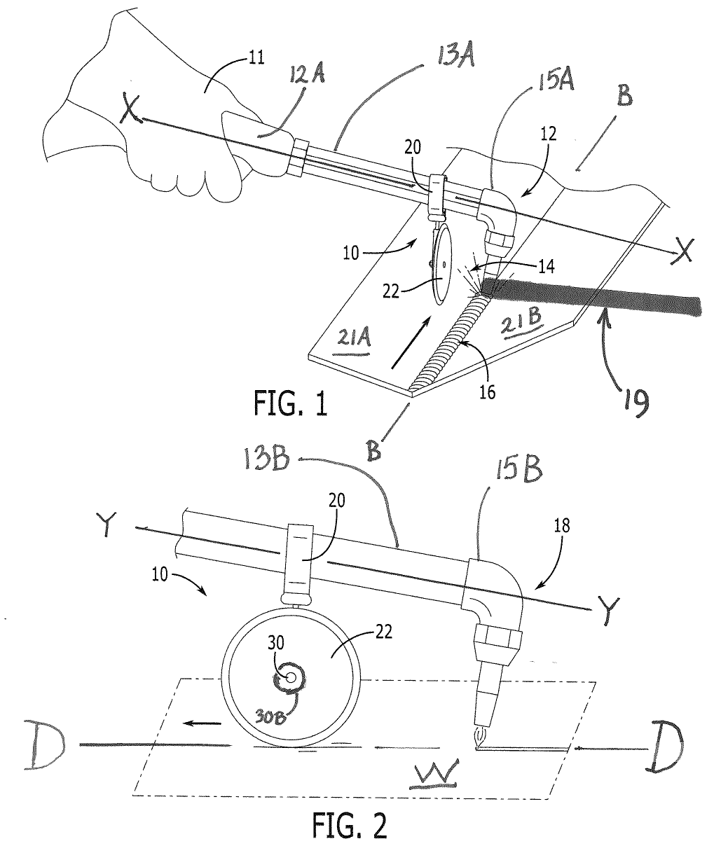

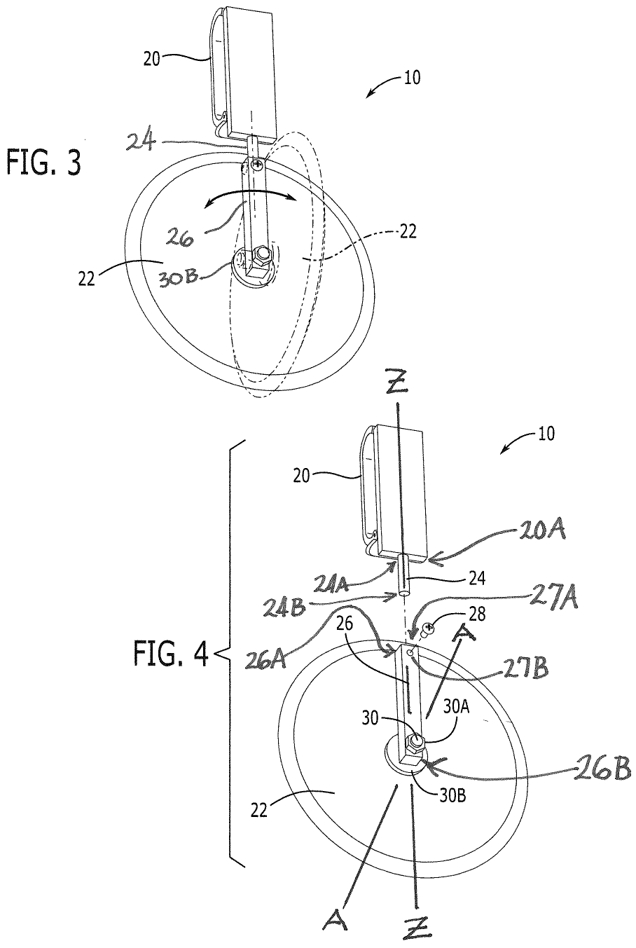

Referring initially to FIGS. 1, 3 and 4, an illustrated embodiment of the present subject matter shall now be described in detail in connection with a simplified example of a prior art welding device or apparatus 12. Welding apparatus 12 includes a handle 12A.

The welding apparatus 12 also includes an elongated neck 13A secured to the handle 12A. The neck 13A is disposed along a first axis X-X. Welding apparatus 12 also includes a head 15A spaced from the handle 12A and secured to an end portion of the neck 13A. The welding apparatus 12 associated with the illustrated embodiment of the present subject matter includes a plurality of welding rods 19, with one shown in FIG. 1.

U.S. Pat. No. 2,963,072 to Swartz (for a thermoplastic welding device); U.S. Pat. No. 3,562,478 to Bennett et al. (for a resistance welding apparatus); U.S. Pat. No. 4,099,044 to Blair et al. (for a welding apparatus); U.S. Pat. No. 4,709,133 to Mainville (for a welding device for applying parallel welds to workpieces); U.S. Pat. No. 4,832,322 to Christenson (for a drum welding apparatus); U.S. Pat. No. 5,313,034 to Grimm et al. (for thermoplastic welding); and U.S. Pat. No. 6,031,199 to Ream et al. (for laser cutting and blank welding) are hereby each incorporated by reference in their entirety. Therefore, head 15A of welding apparatus 12 can include known means for melting an end portion of the rod 19.

A current embodiment of the present subject matter is directed to an assembly mechanism 10 removably fixed or secured to neck 13A. The assembly 10 comprises a clamp 20, a cylindrical member 24, a mounting shaft 26, and a wheel or circular disc 22.

The clamp 20 is removably fixed or secured to the neck 13A. Clamp 20 has an end portion 20A disposed toward a pair of abutting workpieces 21A, 21B spaced from the neck 13A. The cylindrical member 24 is oriented along a second axis Z-Z. The cylindrical member 24 includes a spaced-apart pair of opposite end portions 24A, 24B, where one end portion 24B is a square drive ¼″ standard quick connect style. One 24A of the cylindrical member end portions 24A, 24B is secured to the clamp end portion 20A.

Mounting shaft 26 has opposite end portions 26A, 26B. One end portion 26A of shaft end portions 26A, 26B defines a first bore 27A and a second bore 27B disposed transverse (e.g., 90 degrees) to the first bore 27A. First bore 27A is sized and configured for rotatably receiving the other end portion 24B of the cylindrical member end portions 24A, 24B. Second bore 27B is dimensioned, adapted, and configured (e.g., with internal threads) for threadedly receiving a set screw 28 used for removably securing mounting shaft 26 to the other end portion 24B of the cylindrical member end portions 24A, 24B.

The circular disc 22 is mounted rotatably about a third axis A-A to the other end portion 26B of the mounting shaft end portions 26A, 26B. The first and third axes X-X, A-A are spaced apart and parallel. Disc 22 contacts one workpiece 21A of the two abutting workpieces 21A, 21B shown in FIG. 1. In operation, the circular disc 22 is caused to rotatably contact (by a person or mechanism) and to travel along a surface of said one 21A of the workpieces 21A and 21B. Welding rod 19 is oriented such that the melting means, when operative, causes a linear arrangement of weld beads 16 (FIG. 1) which form along a fourth axis B-B. Disc 22 blocks sparks 14 from injuring a welder's hand 11.

In connection with embodiments of the present subject matter, the workpieces 21A, 21B could be planar. In connection with other embodiments, workpieces 21A, 21B could each be made of a metallic material or a thermoplastic material. In addition, welding rod 19 could comprise a metallic composition or could comprise a thermoplastic composition.

When the assembly 10 of the present subject matter is secured to a welding device or apparatus 12, the second and third axes Z-Z, A-A (FIG. 4) intersect and are oriented transverse (e.g., 90 degrees) to each other, while the first and fourth axes X-X, B-B (see FIG. 1), also oriented transverse (e.g., 90 degrees) to each other, are spaced apart.

Referring next to FIGS. 2-4, the illustrated embodiment of the present subject matter shall now be described in detail in connection with a simplified example of a prior art cutting apparatus 18. The cutting apparatus 18 includes an elongated neck 13B oriented along a first axis Y-Y and a head 15B secured to an end portion of neck 13B.

U.S. Pat. No. 3,749,320 to Langer et al. (for oxygen cutting and welding torches); U.S. Pat. No. 3,804,391 to Case (for a cutting torch guide attachment); U.S. Pat. No. 3,982,883 to Etter (for a method of flame cutting); U.S. Pat. No. 4,134,576 to Livick (for a carriage for an acetylene torch); and U.S. Pat. No. 4,344,606 to Dillon (for a welding and cutting handpiece) are hereby each incorporated by reference in their entirety. Therefore, the head 15B of the illustrated cutting apparatus 18 can include known means for cutting a workpiece W.

In connection with the cutting device or apparatus 18, the assembly mechanism 10 comprises the clamp 20, the cylindrical member 24, the mounting shaft 26, and the circular disc 22. Clamp 20 is removably secured to the neck 13B of the cutting device or apparatus 18. The clamp 20 defines an end portion 20A disposed toward workpiece W. The cylindrical member 24 is oriented along a second axis Z-Z. The cylindrical member 24 includes a spaced-apart pair of opposite end portions 24A, 24B. One end portion 24A of the cylindrical member end portions 24A, 24B is secured to the clamp end portion 20A.

The mounting shaft 26 has opposite end portions 26A, 26B. One end portion 26A of the shaft end portions 26A, 26B defines a first bore 27A and a second bore 27B oriented transverse to the first bore 27A. The first bore 27A is dimensioned and configured for rotatably receiving the other end portion 24B of the cylindrical member end portions 24A, 24B. The second bore 27B is dimensioned, adapted, and configured (for example, with internal peripheral threads) for threadedly receiving a threaded fastener such as a conventional machine screw 28 which is used to removably secure the mounting shaft 26 to the other end portion 24B of cylindrical member end portions 24A, 24B. Circular disc 22 is preferably rotatably secured to the other end portion 26B of the shaft end portions 26A and 26B by a bolt 30 (FIGS. 2, 4), a nut 30A (FIG. 4), and at least one washer 30B.

Circular disc 22 is rotatably mounted about a third axis A-A to the other one 26B of mounting shaft end portions 26A, 26B. When assembly 10 is operatively fixed to a cutting device or apparatus 18, the first and third axes Y-Y and A-A are spaced apart and oriented transverse (e.g., 90 degrees) to each other. In operation, the cutting means is used to cut the workpiece W along a line that defines a fourth axis D-D (FIG. 2) when head 15B is spaced adjacent to the workpiece W and the circular disc 22 is caused (by a person or mechanism) to rotatably contact and travel along a surface of the workpiece W.

In connection with cutting apparatus 18, the workpiece W can, for example, be planar and can, for example, be made of a metallic material or a thermoplastic material.

The assembly mechanism 10 of the present subject matter can be used by a welder, plasma cutter, or another profession in the field of the present subject matter to produce straight weld beads 16 by moving a hand laterally across the abutting workpieces 21A and 21B (FIG. 1) or by moving his/her hand longitudinally along another workpiece W (FIG. 2) to produce a straight, clean cut simply by untightening the set screw 28, next rotating the disc 22 about axis Z-Z by 90 degrees, and lastly re-tightening set screw 28.

Illustrated and described in this application is a wheeled attachment for a welding or cutting tool. While the present subject matter is described in relation to an exemplary embodiment, the present subject matter is not limited to this embodiment. On the contrary, alternatives, changes, or modifications will become apparent to a person of ordinary skill in the art (“POSITA”) after this application is read and its figures reviewed. Therefore, all alternatives, changes, and modifications are to be treated as forming a part of the present subject matter insofar as they fall within the spirit and the scope of the appended claims.

I claim:

1. In a welding apparatus (12) including a handle (12A), an elongated neck (13A) secured to the handle (12A) and disposed along a first axis (X-X), a head (15A) spaced from the handle (12A) and secured to an end portion of the neck (13A), and a welding rod (19), wherein the head (15A) includes means for melting an end portion of the rod (19),
an assembly (10) comprising:
a clamp (20) removably secured to the neck (13A), wherein the clamp (20) defines an end portion (20A) disposed toward a pair of abutting workpieces (21A, 21B) spaced from the neck (13A);
a cylindrical member (24) oriented along a second axis (Z-Z) and defining a spaced-apart pair of opposite end portions (24A, 24B), wherein one (24A) of the cylindrical member end portions (24A, 24B) is secured to the clamp end portion (20A);
a mounting shaft (26) having opposite end portions (26A, 26B), wherein one (26A) of the shaft end portions (26A, 26B) defines a first bore (27A) and a second bore (27B) disposed transverse to the first bore (27A), wherein the first bore (27A) is dimensioned and configured for rotatably receiving the other one (24B) of the cylindrical member end portions (24A, 24B), and wherein the second bore (27B) is dimensioned and configured for threadedly receiving a machine screw (28) for removably securing the mounting shaft (26) to the other one (24B) of the cylindrical member end portions (24A, 24B); and
a circular disc (22) mounted rotatably about a third axis (A-A) to the other one (26B) of the mounting shaft end portions (26A and 26B), wherein the first and third axes (X-X, A-A) are spaced apart and parallel, wherein the disc (22) contacts one (21A) of the workpieces (21A, 21B), wherein the rod (19) is oriented such that the melting means causes weld beads (16) to form along a fourth axis (B-B) and the disc (22) rotatably contacts and travels along a surface of said one (21A) of the workpieces (21A, 21B).

2. The assembly (10) of claim 1, wherein the workpieces (21A, 21B) are planar.

3. The assembly (10) of claim 1, wherein the welding rod (19) comprises a metallic composition or a thermoplastic composition.

4. The assembly (10) of claim 3, wherein the workpieces (21A, 21B) are each made of a metallic material or a thermoplastic material.

5. The assembly (10) of claim 1, wherein the second and third axes (Z-Z, A-A) intersect and are oriented transverse to each other.

6. The assembly (10) of claim 1, wherein the first and fourth axes (X-X, B-B) are spaced apart and are oriented transverse to each other.

7. In a cutting apparatus (18) including an elongated neck (13B) oriented along a first axis (Y-Y), a head (15B) secured to an end portion of the neck (13B), wherein the head (15B) includes means for cutting a workpiece (W),
an assembly (10) comprising:
a clamp (20) removably secured to the neck (13B), wherein the clamp (20) defines an end portion (20A) disposed toward the workpiece (W);
a cylindrical member (24) oriented along a second axis (Z-Z) and defining a spaced-apart pair of opposite end portions (24A, 24B), wherein one (24A) of the cylindrical member end portions (24A, 24B) is secured to the clamp end portion (20A);
a mounting shaft (26) having opposite end portions (26A, 26B), wherein one (26A) of the shaft end portions (26A, 26B) defines a first bore (27A) and a second bore (27B) oriented transverse to the first bore (27A), wherein the first bore (27A) is dimensioned and configured for rotatably receiving the other one (24B) of the cylindrical member end portions (24A, 24B), and wherein the second bore (27B) is dimensioned and configured for threadedly receiving a machine screw (28) for removably securing the mounting shaft (26) to the other one (24B) of the cylindrical member end portions (24A, 24B); and
a circular disc (22) rotatably mounted about a third axis (A-A) to the other one (26B) of the shaft end portions (26A, 26B), wherein the first and third axes (Y-Y, A-A) are spaced apart and oriented transverse to each other, wherein the cutting means cuts the workpiece (W) along a fourth axis (D-D) when the head (15B) is spaced adjacent to the workpiece (W) and the disc (22) rotatably contacts a surface of the workpiece (W).

8. The assembly (10) of claim 7, wherein the workpiece (W) is planar and is made of a metallic material or a thermoplastic material.

9. The assembly (10) of claim 7, wherein the second and third axes (Z-Z, A-A) intersect and are oriented transverse to each other.

10. The assembly (10) of claim 7, wherein the third and fourth axes (A-A, D-D) are spaced apart and are oriented transverse to each other.
